(19) United States
(12) Patent Application Publication
(10) Pub. No.: US 2016/0239540 A1
(43) Pub. Date: Aug. 18, 2016

(54) Data Query Method and Apparatus, Server, and System

(71) Applicant: Huawei Technologies Co., Ltd., Shenzhen (CN)

(72) Inventor: Kanghui Zheng, Shenzhen (CN)

(21) Appl. No.: 15/139,737

(22) Filed: Apr. 27, 2016

Related U.S. Application Data
(63) Continuation of application No. PCT/CN2014/074618, filed on Apr. 2, 2014.

(30) Foreign Application Priority Data
Oct. 30, 2013 (CN) 201310528794.4

(51) Int. Cl. G06F 17/30

(52) U.S. Cl. CPC G06F 17/30442; G06F 17/30569; G06F 17/30554

(57) ABSTRACT

A data query method, a server, and a system, and relates to the field of computer technologies is presented. The method includes: receiving a first query request sent by a client, where the first query request includes a user identifier; converting the user identifier into a role identifier corresponding to the user identifier, to obtain a second query request, where the role identifier corresponds to at least two user identifiers; detecting whether a result set having a key value matching the role identifier included in the second query request exists in a cache; and if the result set exists in the cache, using the result set as a query result and feeding the query result back to the client.

### CROSS-REFERENCE TO RELATED APPLICATIONS

This application is a continuation of International Application No. PCT/CN2014/074618, filed on Apr. 2, 2014, which claims priority to Chinese Patent Application No. 201310528794.4, filed on Oct. 30, 2013, both of which are hereby incorporated by reference in their entireties.

### TECHNICAL FIELD

The present disclosure relates to the field of computer technologies, and in particular, to a data query method and apparatus, a server, and a system.

### BACKGROUND

With development of database technologies, more data is stored into a database. How to find required data quickly from a large quantity of data has become a focus of attention of people.

An existing data query method includes receiving a query request that is sent by a client and includes a user identifier; detecting whether a result set having a key value matching the query request exists in a cache; and if the result set having a key value matching the query request exists in the cache, feeding the result set back to the client; or if the result set having a key value matching the query request does not exist in the cache, querying, in a database, data matching the user identifier, temporarily storing the data, which is obtained through querying, as a result set using a key value generated according to the user identifier, and feeding the result set back to the client.

However, according to the query method in the prior art, different users of one client may query a same result set. In this case, the reusing efficiency of a result set is extremely low, and therefore the data query efficiency is not high.

### SUMMARY

Embodiments of the present disclosure provide a data query method and apparatus, a server, and a system, so as to improve the data query efficiency to some extent. The technical solutions are as follows:

According to a first aspect, an embodiment of the present disclosure provides a data query method, where the method includes receiving a first query request sent by a client, where the first query request includes a user identifier; converting the user identifier into a role identifier corresponding to the user identifier, to obtain a second query request, where the role identifier corresponds to at least two user identifiers; detecting whether a result set having a key value matching the role identifier included in the second query request exists in a cache; and if the result set exists in the cache, using the result set as a query result and feeding the query result back to the client.

In a first possible implementation manner of the first aspect, if the first query request further includes a filter criterion, the detecting whether a result set having a key value matching the role identifier included in the second query request exists in a cache includes detecting whether a result set having a key value matching the role identifier and the filter criterion that are included in the second query request exists in the cache.

With reference to the first aspect or the first possible implementation manner of the first aspect, in a second possible implementation manner of the first aspect, the converting the user identifier into a role identifier corresponding to the user identifier, to obtain a second query request includes acquiring a prestored mapping relationship between the user identifier and the role identifier; and changing the user identifier into the role identifier according to the mapping relationship, to obtain the second query request.

With reference to the first aspect, the first possible implementation manner of the first aspect, or the second possible implementation manner of the first aspect, in a third possible implementation manner of the first aspect, the method further includes, if the result set does not exist in the cache and the second query request includes the role identifier, detecting whether data matching the role identifier exists in a database; and if the data exists in the database, temporarily storing the data as a result set using a key value generated according to the role identifier, using the result set as a query result, and feeding the query result back to the client; and if the result set does not exist in the cache and the second query request includes the role identifier and the filter criterion, detecting whether data matching the role identifier and the filter criterion exists in a database; and if the data exists in the database, temporarily storing the data as a result set using a key value that is generated according to the role identifier and the filter criterion, using the result set as a query result, and feeding the query result back to the client.

With reference to the first aspect, the first possible implementation manner of the first aspect, the second possible implementation manner of the first aspect, or the third possible implementation manner of the first aspect, in a fourth possible implementation manner of the first aspect, if there are at least two role identifiers corresponding to the user identifier, there are at least two second query requests that are in a one-to-one correspondence with the role identifiers, and the using the result set as a query result and feeding the query result back to the client includes combining result sets that are obtained through detection according to the second query requests and feeding a combined result back to the client.

According to a second aspect, an embodiment of the present disclosure provides a data query apparatus, where the apparatus includes a request receiving module configured to receive a first query request sent by a client, where the first query request includes a user identifier; a request conversion module configured to convert the user identifier received by the request receiving module into a role identifier corresponding to the user identifier, to obtain a second query request, where the role identifier corresponds to at least two user identifiers; a request detection module configured to detect whether a result set having a key value matching the role identifier included in the second query request obtained through conversion by the request conversion module exists in a cache; and a first feedback module configured to, if the request detection module detects that the result set exists in the cache, use the result set as a query result and feed the query result back to the client.

In a first possible implementation manner of the second aspect, if the first query request further includes a filter criterion, the request detection module is configured to detect whether a result set having a key value matching the role identifier and the filter criterion that are included in the second query request exists in the cache.

With reference to the second aspect or the first possible implementation manner of the second aspect, in a second possible implementation manner of the second aspect, the request conversion module is configured to acquire a prestored mapping relationship between the user identifier and the role identifier; and change the user identifier into the role identifier according to the mapping relationship, to obtain the second query request.

With reference to the second aspect, the first possible implementation manner of the second aspect, or the second possible implementation manner of the second aspect, in a third possible implementation manner of the second aspect, the apparatus further includes a second feedback module configured to, if the request detection module detects that the result set does not exist in the cache and the second query request includes the role identifier, detect whether data matching the role identifier exists in a database; and if the data exists in the database, temporarily store the data as a result set using a key value generated according to the role identifier, use the result set as a query result, and feed the query result back to the client; and a third feedback module configured to, if the request detection module detects that the result set does not exist in the cache and the second query request includes the role identifier and the filter criterion, detect whether data matching the role identifier and the filter criterion exists in a database; and if the data exists in the database, temporarily store the data as a result set using a key value that is generated according to the role identifier and the filter criterion, use the result set as a query result, and feed the query result back to the client.

With reference to the second aspect, the first possible implementation manner of the second aspect, the second possible implementation manner of the second aspect, or the third possible implementation manner of the second aspect, in a fourth possible implementation manner of the second aspect, if there are at least two role identifiers corresponding to the user identifier, there are at least two second query requests that are in a one-to-one correspondence with the role identifiers; and the first feedback module is configured to combine result sets that are obtained through detection according to the second query requests and feed a combined result back to the client; the second feedback module is configured to combine result sets that are obtained through detection according to the second query requests and feed a combined result back to the client; or the third feedback module is configured to combine result sets that are obtained through detection according to the second query requests and feed a combined result back to the client.

According to a third aspect, an embodiment of the present disclosure provides a data query apparatus, where the apparatus includes a receiver configured to receive a first query request sent by a client, where the first query request includes a user identifier; a processor configured to convert the user identifier received by the receiver into a role identifier corresponding to the user identifier, to obtain a second query request, where the role identifier corresponds to at least two user identifiers; and detect whether a result set having a key value matching the role identifier included in the second query request exists in a cache; and a transmitter configured to, if the processor detects that the result set exists in the cache, use the result set as a query result and feed the query result back to the client.

In a first possible implementation manner of the third aspect, if the first query request further includes a filter criterion, the processor is configured to detect whether a result set having a key value matching the role identifier and the filter criterion that are included in the second query request exists in the cache.

With reference to the third aspect or the first possible implementation manner of the third aspect, in a second possible implementation manner of the third aspect, the processor is configured to acquire a prestored mapping relationship between the user identifier and the role identifier; and change the user identifier into the role identifier according to the mapping relationship, to obtain the second query request.

With reference to the third aspect, the first possible implementation manner of the third aspect, or the second possible implementation manner of the third aspect, in a third possible implementation manner of the third aspect, the processor is further configured to, if the result set does not exist in the cache and the second query request includes the role identifier, detect whether data matching the role identifier exists in a database, and if the data exists in the database, temporarily store the data as a result set using a key value generated according to the role identifier; and the transmitter is further configured to use the result set as a query result and feed the query result back to the client; and the processor is configured to, if the result set does not exist in the cache and the second query request includes the role identifier and the filter criterion, detect whether data matching the role identifier and the filter criterion exists in a database, and if the data exists in the database, temporarily store the data as a result set using a key value that is generated according to the role identifier and the filter criterion; and the transmitter is further configured to use the result set as a query result and feed the query result back to the client.

With reference to the third aspect, the first possible implementation manner of the third aspect, the second possible implementation manner of the third aspect, or the third possible implementation manner of the third aspect, in a fourth possible implementation manner of the third aspect, if there are at least two role identifiers corresponding to the user identifier, there are at least two second query requests that are in a one-to-one correspondence with the role identifiers, and the transmitter is configured to combine result sets that are obtained through detection according to the second query requests and feed a combined result back to the client.

According to a fourth aspect, an embodiment of the present disclosure provides a data query system, including a client and a server, where the client is configured to send a first query request, where the first query request includes a user identifier; and the server is configured to receive the first query request that is sent by the client and includes the user identifier; convert the user identifier into a role identifier corresponding to the user identifier, to obtain a second query request, where the role identifier corresponds to at least two user identifiers; detect whether a result set having a key value matching the role identifier included in the second query request exists in a cache; and if the result set exists in the cache, use the result set as a query result and feed the query result back to the client.

In a first possible implementation manner of the fourth aspect, if the first query request further includes a filter criterion, the server is configured to detect whether a result set having a key value matching the role identifier and the filter criterion that are included in the second query request exists in the cache.

With reference to the fourth aspect or the first possible implementation manner of the fourth aspect, in a second possible implementation manner of the fourth aspect, the server is configured to acquire a prestored mapping relationship between the user identifier and the role identifier; and change the user identifier into the role identifier according to the mapping relationship, to obtain the second query request.

With reference to the fourth aspect, the first possible implementation manner of the fourth aspect, or the second possible implementation manner of the fourth aspect, in a third possible implementation manner of the fourth aspect, the server is further configured to, if detecting that the result set does not exist in the cache and the second query request includes the role identifier, detect whether data matching the role identifier exists in a database, and if the data exists in the database, temporarily store the data as a result set using a key value generated according to the role identifier, use the result set as a query result, and feed the query result back to the client; and if detecting that the result set does not exist in the cache and the second query request includes the role identifier and the filter criterion, detect whether data matching the role identifier and the filter criterion exists in a database, and if the data exists in the database, temporarily store the data as a result set using a key value that is generated according to the role identifier and the filter criterion, use the result set as a query result, and feed the query result back to the client.

With reference to the fourth aspect, the first possible implementation manner of the fourth aspect, the second possible implementation manner of the fourth aspect, or the third possible implementation manner of the fourth aspect, in a fourth possible implementation manner of the fourth aspect, if there are at least two role identifiers corresponding to the user identifier, there are at least two second query requests that are in a one-to-one correspondence with the role identifiers, and the server is configured to combine result sets that are obtained through detection according to the second query requests and feed a combined result back to the client.

As can be seen, according to the embodiments of the present disclosure, it may be set that at least two user identifiers correspond to a same role identifier, and the user identifiers are converted into the corresponding role identifier in a query process, so that a result set that is obtained through querying according to the role identifier may be reused by different clients corresponding to the same role identifier, which resolves a problem in the existing data query method that because of different user identifiers of clients, a reusing rate of a result set is extremely low and the data query efficiency is lowered, and achieves an effect of improving the reusing efficiency of a result set and the data query efficiency.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic method flowchart of a data query method according to an embodiment of the present disclosure;

FIG. 2A is a schematic method flowchart of a data query method according to another embodiment of the present disclosure;

FIG. 2B is a schematic diagram of application of a data query method according to an embodiment of the present disclosure;

FIG. 3 is a schematic structural diagram of a data query apparatus according to an embodiment of the present disclosure;

FIG. 4 is a schematic structural diagram of a data query apparatus according to another embodiment of the present disclosure;

FIG. 5 is a schematic structural diagram of a data query apparatus according to an embodiment of the present disclosure; and

FIG. 6 is a schematic structural diagram of a data query system according to an embodiment of the present disclosure.

### DESCRIPTION OF EMBODIMENTS

To make the objectives, technical solutions, and advantages of the present disclosure clearer, the following further describes the implementation manners of the present disclosure in detail with reference to the accompanying drawings.

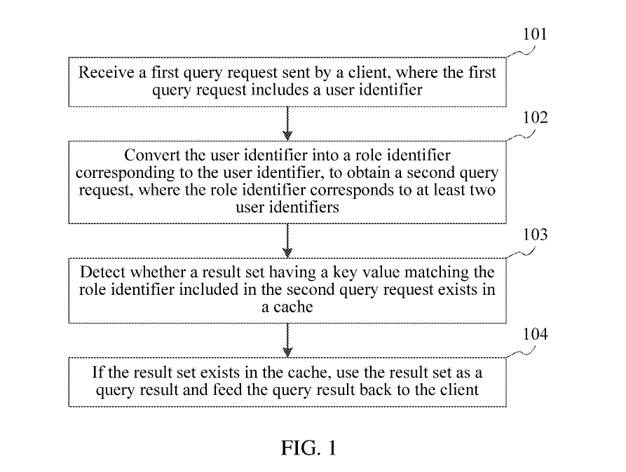

Referring to FIG. 1, FIG. 1 is a schematic method flowchart of a data query method according to an embodiment of the present disclosure. The data query method may be applied to a server configured to distribute query requests. The data query method includes the following.

Step 101: Receive a first query request sent by a client, where the first query request includes a user identifier.

The user identifier may be an account, an identity ID, or the like, and is used for data query. For example, if the user identifier is a game account, all game records included in the game account may be queried according to the first query request including the user identifier. If the user identifier is an ID, all devices managed by the ID may be queried according to the first query request including the user identifier.

One user identifier may correspond to only one client, for example, the user identifier is a unique identification code of a mobile phone. Alternatively, one user identifier may correspond to at least two clients. For example, the user identifier is an account that may be logged in to in a mobile phone and a computer. Generally, one user identifier corresponds to one client.

Step 102: Convert the user identifier into a role identifier corresponding to the user identifier, to obtain a second query request, where the role identifier corresponds to at least two user identifiers.

An existing key value of a result set is determined by the first query request, that is, when the first query request includes the user identifier, an obtained key value of a result set is generated according to the user identifier. However, user identifiers of different clients are generally different. Therefore, reusability of a result set is extremely low. The key value is used to identify the result set.

To resolve the foregoing problem, in this embodiment, a role identifier corresponding to at least two user identifiers is set, so that the second query request includes the role identifier; and a key value, obtained according to the second query request, of a result set is generated according to the role identifier, so that the result set may be reused by at least two clients corresponding to the same role identifier, which improves reusability of the result set.

In a process of generating the second query request, the user identifier in the first query request may be converted into the role identifier corresponding to the user identifier, and then it is determined that a query request including the role identifier is the second query request.

Step 103: Detect whether a result set having a key value matching the role identifier included in the second query request exists in a cache, and if the result set exists in the cache, perform step 104.

Because a key value of a result set is generated according to a role identifier, a method for detecting whether a result set having a key value matching a role identifier exists is related to a method for generating a key value of a result set. When a key value includes a role identifier, it is detected whether a result set having a key value the same as the role identifier exists. When a key value is obtained by calculating a role identifier according to a predetermined algorithm, the role identifier may be calculated according to the predetermined algorithm, to detect whether a result obtained through calculation is equal to the key value; or the key value may be calculated according to a reverse algorithm of the predetermined algorithm, to detect whether a result obtained through calculation is the same as the role identifier. Certainly, it may be detected using another method whether the result set having a key value matching the role identifier included in the second query request exists in the cache, which is not limited in this embodiment.

Step 104: Use the result set as a query result and feed the query result back to the client.

In conclusion, according to the data query method provided in this embodiment of the present disclosure, it may be set that at least two user identifiers correspond to a same role identifier, and the user identifiers are converted into the corresponding role identifier in a query process, so that a result set that is obtained through querying according to the role identifier may be reused by different clients corresponding to the same role identifier, which resolves a problem in the existing data query method that because of different user identifiers of clients, a reusing rate of a result set is extremely low and the data query efficiency is lowered, and achieves an effect of improving the reusing efficiency of a result set and the data query efficiency.

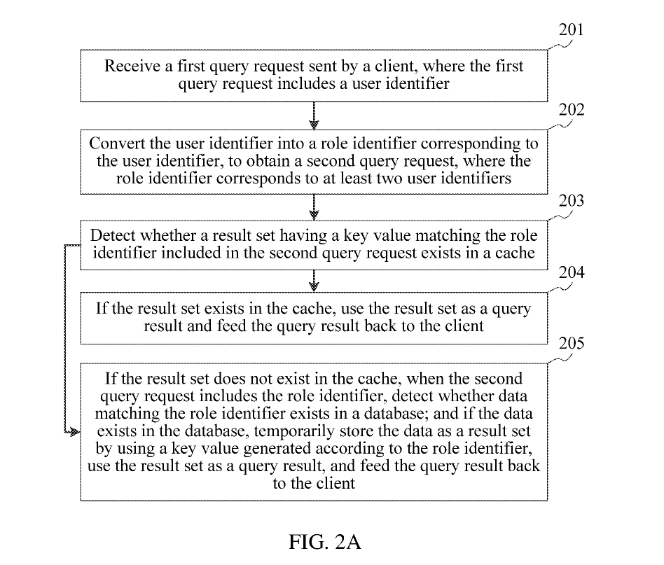

Referring to FIG. 2A, FIG. 2A is a schematic method flowchart of a data query method according to another embodiment of the present disclosure. The data query method may be applied to a server configured to distribute query requests. The data query method includes:

Step 201: Receive a first query request sent by a client, where the first query request includes a user identifier.

This embodiment relates to a data query method, and a received operation request sent by the client may be a query request, an addition request, a change request, a deletion request, or the like. Therefore, it is further required to detect whether the received operation request is a query request.

The receiving a first query request sent by a client includes: 1) receiving an operation request sent by the client; 2) detecting whether the operation request meets a predetermined format; and 3) if the operation request meets the predetermined format, determining that the operation request is the first query request.

Because each request type has a specified format, a format of the query request may be set to a predetermined format in advance, and after an operation request is received, a format of the operation request is acquired to detect whether the format meets the predetermined format. If the format meets the predetermined format, it is determined that the received operation format is a query request, and the process proceeds to step 202; or if the format does not meet the predetermined format, it is determined that the received operation format is not a query request, and the process ends. The predetermined format may be stored in a database, or the predetermined format may be stored in a cache, so as to improve the detection efficiency of a request type, which is not limited in this embodiment.

First, if it is detected that the received operation request is a query request, it may be determined that the query request is the first query request including the user identifier, where the user identifier may be an account, an ID, or the like, and is used for data query. For example, if the user identifier is a game account, all game records included in the game account may be queried according to the first query request including the user identifier; if the user identifier is an ID, all device data managed by the ID may be queried according to the first query request including the user identifier.

One user identifier may correspond to only one client, for example, the user identifier is a unique identification code of a mobile phone. Alternatively, one user identifier may correspond to at least two clients, for example, the user identifier is an account that may be logged in to in a mobile phone and a computer. Generally, one user identifier corresponds to one client.

Second, if it is detected that the received operation request is a query request, it may be further determined that the query request is a first query request that includes the user identifier and a filter criterion, where the filter criterion is used for data query. For example, the filter criterion is to find valid data in a database, to find a phone number of a contact in a contact list, or the like.

When the first query request includes the user identifier and the filter criterion, data may be further queried with reference to the user identifier and the filter criterion. For example, all grouping data of an instant messaging account is determined according to the user identifier, and buddy grouping data in all of the grouping data included in the account is determined according to the filter criterion.

Step 202: Convert the user identifier into a role identifier corresponding to the user identifier, to obtain a second query request, where the role identifier corresponds to at least two user identifiers.

An existing key value of a result set is determined by the first query request. If the first query request includes the user identifier, an obtained key value of a result set is generated according to the user identifier. If the first query request includes the user identifier and the filter criterion, an obtained key value of a result set is generated according to the user identifier and the filter criterion. However, user identifiers of different clients are generally different. Therefore, reusability of a result set is extremely low. The key value is used to identify the result set.

To resolve the foregoing problem, in this embodiment, a role identifier corresponding to at least two user identifiers is set, so that the second query request includes the role identifier; and a key value, obtained according to the second query request, of a result set is generated according to the role identifier, so that the result set may be reused by at least two clients corresponding to the same role identifier, which improves reusability of the result set.

In a process of generating the second query request, if the first query request includes the user identifier, the user identifier in the first query request may be converted into the role identifier corresponding to the user identifier, and then it is determined that a query request including the role identifier is the second query request; or if the first query request includes the user identifier and the filter criterion, the user identifier in the first query request may be converted into the role identifier and the filter criterion is not changed, and then it is determined that a query request that includes the role identifier and the filter criterion is the second query request.

The converting the user identifier into a role identifier corresponding to the user identifier, to obtain a second query request includes: 1) acquiring a prestored mapping relationship between the user identifier and the role identifier; and 2) changing the user identifier into the role identifier according to the mapping relationship, to obtain the second query request.

The mapping relationship may be set or modified by a user in advance and is stored in a distributed server, which is not limited in this embodiment. One user identifier may be in a mapping relationship with at least one role identifier.

Preferably, to improve efficiency of converting the user identifier into the role identifier, after the mapping relationship between the user identifier and the role identifier is acquired for the first time, the mapping relationship may be stored in a cache. If another client needs to acquire the mapping relationship subsequently, another client may read the mapping relationship from the cache preferentially, which saves an operation of searching a distributed system for the mapping relationship.

Step 203: Detect whether a result set having a key value matching the role identifier included in the second query request exists in a cache, and if the result set exists in the cache, perform step 204; or if the result set does not exist in the cache, perform step 205.

Because a key value of a result set is generated according to a role identifier, a method for detecting whether a result set having a key value matching a role identifier exists is related to a method for generating a key value of a result set. When a key value includes a role identifier, it is detected whether a result set having a key value the same as the role identifier exists. When a key value is obtained by calculating a role identifier according to a predetermined algorithm, the role identifier may be calculated according to the predetermined algorithm, to detect whether a result obtained through calculation is equal to the key value; or the key value may be calculated according to a reverse algorithm of the predetermined algorithm, to detect whether a result obtained through calculation is the same as the role identifier. Certainly, it may be detected using another method whether the result set having a key value matching the role identifier included in the second query request exists in the cache, which is not limited in this embodiment.

In this embodiment, if the first query request further includes the filter criterion, the detecting whether a result set having a key value matching the role identifier included the second query request exists in a cache includes detecting whether a result set having a key value matching the role identifier and the filter criterion that are included in the second query request exists in the cache.

A method for detecting whether a result set having a key value matching a role identifier and a filter criterion exists is related to a method for generating a key value of a result set. When a key value includes a role identifier and a filter criterion, it is detected whether a result set having a key value the same as the role identifier and the filter criterion exists. When a key value is obtained by calculating a role identifier and a filter criterion according to a predetermined algorithm, the role identifier and the filter criterion may be calculated according to the predetermined algorithm, to detect whether a result obtained through calculation is equal to the key value; or the key value may be calculated according to a reverse algorithm of the predetermined algorithm, to detect whether a result obtained through calculation is the same as the role identifier and the filter criterion. Certainly, it may be detected using another method whether the result set having a key value matching the role identifier and the filter criterion that are included in the second query request exists in the cache, which is not limited in this embodiment.

It should be supplementary noted that, when the result set is temporarily stored, a timing operation on the result set may be further enabled. If the result set exists in the cache and a timing result does not reach a timing threshold of the result set, it is determined that the result set is valid, and in this case, step 204 is performed; or if the result set exists in the cache and a timing result reaches a timing threshold of the result set, it is determined that the result set is invalid, and in this case, step 205 is performed.

The timing threshold is related to an update cycle of data. If the update cycle of the data is relatively short, the timing threshold is relatively short; or if the update cycle of the data is relatively long, the timing threshold is relatively long. Statistics may be collected on an average update cycle of the data according to a data type, and it is determined that the average update cycle obtained through statistics collection is the timing threshold. Certainly, the timing threshold of the result set may also be determined in another manner, which is not limited in this embodiment.

Step 204: Use the result set as a query result and feed the query result back to the client, and the process ends.

Because the result set matching the second query request exists in the cache, the result set may be directly fed back to the client, which saves an operation of performing data query in a database according to the second query request, and improves the data query efficiency.

Step 205: If the second query request includes the role identifier, detect whether data matching the role identifier exists in a database; and if the data exists in the database, temporarily store the data as a result set using a key value generated according to the role identifier, use the result set as a query result, and feed the query result back to the client.

When the first query request includes the user identifier, the second query request includes the role identifier. In this case, it may be detected whether the data matching the role identifier exists in the database, and obtained data is temporarily stored as a result set using a key value generated according to the role identifier.

In this embodiment, when the second query request includes the role identifier and the filter criterion, it is detected whether data matching the role identifier and the filter criterion exists in a database; and if the data exists in the database, the data is temporarily stored as a result set using a key value that is generated according to the role identifier and the filter criterion, the result set is used as a query result, and the query result is fed back to the client. When the first query request includes the user identifier and the filter criterion, the second query request includes the role identifier and the filter criterion. In this case, it may detected whether the data matching the role identifier and the filter criterion exists in the database, and obtained data is temporarily stored as a result set using a key value that is generated according to the role identifier and the filter criterion.

Further, if there are at least two role identifiers corresponding to the user identifier, there are at least two second query requests that are in a one-to-one correspondence with the role identifiers, and the using the result set as a query result and feeding the query result back to the client includes combining result sets that are obtained through detection according to the second query requests and feeding a combined result back to the client.

In this embodiment, at least two role identifiers are set for a user identifier, so that a union set of result sets that are obtained through detection according to second query requests may be acquired by means of one query, which resolves a problem of low data query efficiency that is caused by the fact that one result set is obtained in one query, and achieves an effect of improving the data query efficiency. Moreover, performing data query according to at least two second query requests also extends a data query range, so that data obtained through querying is more comprehensive and a data query effect is optimized.

If the user identifier corresponds to at least two role identifiers, at least two second query requests may be obtained. For each second query request, it is first queried whether a result set having a key value matching the second query request exists in the cache, and if the result set having a key value matching the second query request exists, the result set is read; or if the result set having a key value matching the second query request does not exist, data query is performed in the database according to the second query request, and found data is temporarily stored as a result set. After a result set corresponding to each second query request is determined, all result sets are combined, and a union set after combining is sent to the client.

It should be supplementary noted that, because each client has a client identifier, for example, an Internet Protocol (IP) address and a port number, when the second query request that is obtained after conversion according to the first query request sent by the client is acquired, a correspondence between a client identifier of the client sending the first query request and the second query request is recorded, and after a result set is acquired according to the second query request, a client identifier of a client that needs to receive the result set may be determined according to the correspondence, thereby accurately feeding the result set back to the client indicated by the client identifier and improving data query accuracy.

Preferably, step 201, and step 203 to step 205 may be implemented as a server, and step 202 may be implemented as a plug-in. The plug-in may be independent from the server; or, to reduce time consumed for establishing a connection between the plug-in and the server and improve the data search efficiency, the plug-in may be further located in the server.

When the plug-in is located in the server, the server may be implemented in a first language, and the plug-in may be implemented in a second language, so as to ensure that the server and the plug-in have relatively low coupling. When an error occurs in the plug-in in a running process, the relatively low coupling enables that the error of the plug-in does not affect running of the server, so that the server can still perform data query, which improves availability of the server. The second language may be a scripting language, so that the plug-in has relatively high processing efficiency and occupies a relatively small quantity of resources.

Refer to a schematic diagram of application of a data query method shown in FIG. 2B. To facilitate understanding, a specific example is used for description in this embodiment. In FIG. 2B, a plug-in is implemented as a part of a server; and a result set in a cache is implemented as a specific result set cache server, and the result set cache server interacts with a database using an application server. The example is as follows:

Step 1: A client sends an operation request to a server.

Step 2: The server detects whether the operation request meets a predetermined format, and if the operation request meets the predetermined format, it is determined that the operation request is a first query request, where the first query request includes a user identifier or both of a user identifier and a filter criterion.

Step 3: The server invokes a plug-in to convert the user identifier into a role identifier, to obtain a second query request.

Step 4: The server sends the second query request to a result set cache server.

Step 5: The result set cache server searches for a result set having a key value matching the second query request, and if the result set is found, feeds the result set back to the server, and performs step 6; or if the result set is not found, feeds response information, indicating that the result set is not found, back to the server, and performs step 7.

Step 6: The server feeds the received result set back to the client, and the process ends.

Step 7: The server sends the second query request to an application server.

Step 8: The application server searches a database for data matching the second query request, and feeds found data back to the server.

Step 9: The server temporarily stores the data into the result set cache server.

Step 10: The server feeds the result set back to the client, and the process ends.

In conclusion, according to the data query method provided in this embodiment of the present disclosure, it may be set that at least two user identifiers correspond to a same role identifier, and the user identifiers are converted into the corresponding role identifier in a query process, so that a result set that is obtained through querying according to the role identifier may be reused by different clients corresponding to the same role identifier, which resolves a problem in the existing data query method that because of different user identifiers of clients, a reusing rate of a result set is extremely low and the data query efficiency is lowered, and achieves an effect of improving the reusing efficiency of a result set and the data query efficiency. In addition, if there are at least two role identifiers corresponding to a user identifier, there are at least two second query requests that are in a one-to-one correspondence with the role identifiers; and result sets obtained through detection according to second query requests are combined and a combined result is fed back to a client, so that a union set of the result sets that are obtained through detection according to the second query requests may be acquired by means of one query, which resolves a problem of low data query efficiency that is caused by the fact that one result set is obtained in one query, and achieves an effect of improving the data query efficiency.

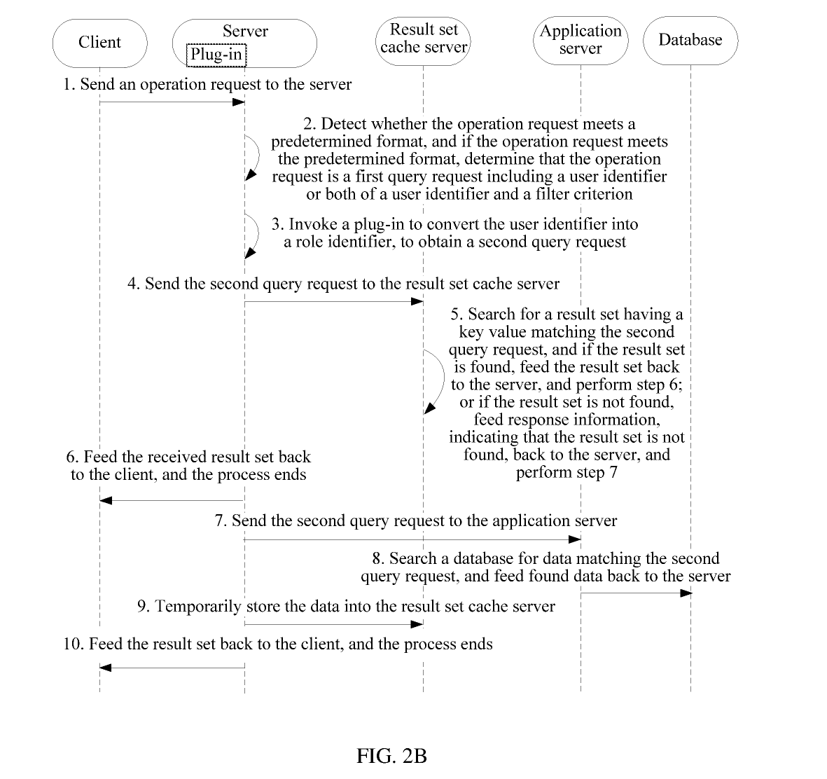

Referring to FIG. 3, FIG. 3 is a schematic structural diagram of a data query apparatus 300 according to an embodiment of the present disclosure. The data query apparatus 300 may be applied to a server configured to distribute query requests. The data query apparatus 300 includes a request receiving module 310 configured to receive a first query request sent by a client, where the first query request includes a user identifier; a request conversion module 320 configured to convert the user identifier received by the request receiving module 310 into a role identifier corresponding to the user identifier, to obtain a second query request, where the role identifier corresponds to at least two user identifiers; a request detection module 330 configured to detect whether a result set having a key value matching the role identifier included in the second query request obtained through conversion by the request conversion module 320 exists in a cache; and a first feedback module 340 configured to, if the request detection module 330 detects that the result set exists in the cache, use the result set as a query result and feed the query result back to the client.

In conclusion, according to the data query apparatus provided in this embodiment of the present disclosure, it may be set that at least two user identifiers correspond to a same role identifier, and the user identifiers are converted into the corresponding role identifier in a query process, so that a result set that is obtained through querying according to the role identifier may be reused by different clients corresponding to the same role identifier, which resolves a problem in the existing data query method that because of different user identifiers of clients, a reusing rate of a result set is extremely low and the data query efficiency is lowered, and achieves an effect of improving the reusing efficiency of a result set and the data query efficiency.

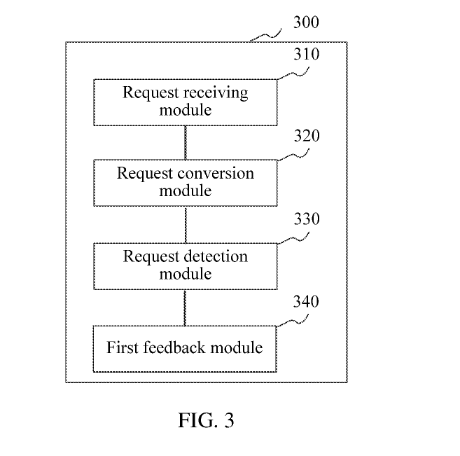

Referring to FIG. 4, FIG. 4 is a schematic structural diagram of a data query apparatus 300 according to another embodiment of the present disclosure. The data query apparatus 300 may be applied to a server configured to distribute query requests. The data query apparatus 300 includes a request receiving module 310, a request conversion module 320, a request detection module 330, and a first feedback module 340.

The request receiving module 310 is configured to receive a first query request sent by a client, where the first query request includes a user identifier.

The request conversion module 320 is configured to convert the user identifier received by the request receiving module 310 into a role identifier corresponding to the user identifier, to obtain a second query request, where the role identifier corresponds to at least two user identifiers.

The request detection module 330 is configured to detect whether a result set having a key value matching the role identifier included in the second query request obtained through conversion by the request conversion module 320 exists in a cache.

The first feedback module 340 is configured to, if the request detection module 330 detects that the result set exists in the cache, use the result set as a query result and feed the query result back to the client.

If the first query request further includes a filter criterion, the request detection module 330 is configured to detect whether a result set having a key value matching the role identifier and the filter criterion that are included in the second query request exists in the cache.

The request conversion module 320 is configured to acquire a prestored mapping relationship between the user identifier and the role identifier; and change the user identifier into the role identifier according to the mapping relationship, to obtain the second query request.

Further, the data query apparatus 300 further includes a second feedback module 350 configured to, if the request detection module 330 detects that the result set does not exist in the cache and the second query request includes the role identifier, detect whether data matching the role identifier exists in a database; and if the data exists in the database, temporarily store the data as a result set using a key value generated according to the role identifier, use the result set as a query result, and feed the query result back to the client; and a third feedback module 360 configured to, if the request detection module 330 detects that the result set does not exist in the cache and the second query request includes the role identifier and the filter criterion, detect whether data matching the role identifier and the filter criterion exists in a database; and if the data exists in the database, temporarily store the data as a result set using a key value that is generated according to the role identifier and the filter criterion, use the result set as a query result, and feed the query result back to the client.

If there are at least two role identifiers corresponding to the user identifier, there are at least two second query requests that are in a one-to-one correspondence with the role identifiers; and the first feedback module 340 is configured to combine result sets that are obtained through detection according to the second query requests and feed a combined result back to the client; the second feedback module 350 is configured to combine result sets that are obtained through detection according to the second query requests and feed a combined result back to the client; or the third feedback module 360 is configured to combine result sets that are obtained through detection according to the second query requests and feed a combined result back to the client.

In conclusion, according to the data query apparatus provided in this embodiment of the present disclosure, it may be set that at least two user identifiers correspond to a same role identifier, and the user identifiers are converted into the corresponding role identifier in a query process, so that a result set that is obtained through querying according to the role identifier may be reused by different clients corresponding to the same role identifier, which resolves a problem in the existing data query method that because of different user identifiers of clients, a reusing rate of a result set is extremely low and the data query efficiency is lowered, and achieves an effect of improving the reusing efficiency of a result set and the data query efficiency. In addition, if there are at least two role identifiers corresponding to a user identifier, there are at least two second query requests that are in a one-to-one correspondence with the role identifiers; and result sets obtained through detection according to second query requests are combined and a combined result is fed back to a client, so that a union set of the result sets that are obtained through detection according to the second query requests may be acquired by means of one query, which resolves a problem of low data query efficiency that is caused by the fact that one result set is obtained in one query, and achieves an effect of improving the data query efficiency.

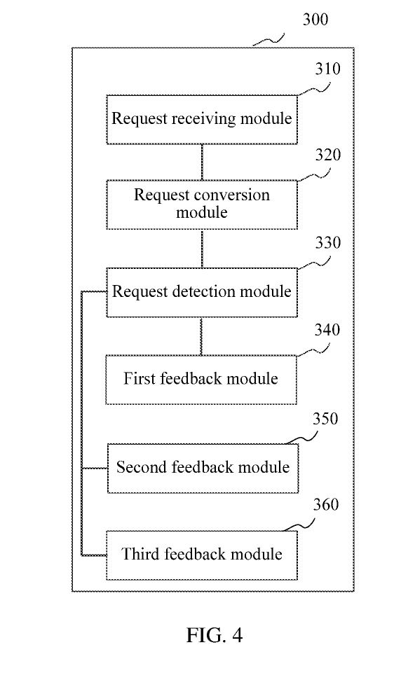

Referring to FIG. 5, FIG. 5 is a schematic structural diagram of a data query apparatus 500 according to an embodiment of the present disclosure. The data query apparatus 500 may be applied to a server configured to distribute query requests. The data query apparatus 500 includes a receiver 510 configured to receive a first query request sent by a client, where the first query request includes a user identifier; a processor 520 configured to convert the user identifier received by the receiver 510 into a role identifier corresponding to the user identifier, to obtain a second query request, where the role identifier corresponds to at least two user identifiers; and detect whether a result set having a key value matching the role identifier included in the second query request exists in a cache; and a transmitter 530 configured to, if the processor 520 detects that the result set exists in the cache, use the result set as a query result and feed the query result back to the client.

In conclusion, according to the data query apparatus provided in this embodiment of the present disclosure, it may be set that at least two user identifiers correspond to a same role identifier, and the user identifiers are converted into the corresponding role identifier in a query process, so that a result set that is obtained through querying according to the role identifier may be reused by different clients corresponding to the same role identifier, which resolves a problem in the existing data query method that because of different user identifiers of clients, a reusing rate of a result set is extremely low and the data query efficiency is lowered, and achieves an effect of improving the reusing efficiency of a result set and the data query efficiency.

A data query apparatus 500 provided in another embodiment of the present disclosure may be applied to a server configured to distribute query requests. The data query apparatus 500 includes a receiver 510, a processor 520, and a transmitter 530.

The receiver 510 is configured to receive a first query request sent by a client, where the first query request includes a user identifier.

The processor 520 is configured to convert the user identifier received by the receiver 510 into a role identifier corresponding to the user identifier, to obtain a second query request, where the role identifier corresponds to at least two user identifiers; and detect whether a result set having a key value matching the role identifier included in the second query request exists in a cache.

The transmitter 530 is configured to, if the processor 520 detects that the result set exists in the cache, use the result set as a query result and feed the query result back to the client.

If the first query request further includes a filter criterion, the processor 520 is configured to detect whether a result set having a key value matching the role identifier and the filter criterion that are included in the second query request exists in the cache.

The processor 520 is configured to acquire a prestored mapping relationship between the user identifier and the role identifier; and change the user identifier into the role identifier according to the mapping relationship, to obtain the second query request.

Further, the processor 520 is further configured to, if the result set does not exist in the cache and the second query request includes the role identifier, detect whether data matching the role identifier exists in a database, and if the data exists in the database, temporarily store the data as a result set using a key value generated according to the role identifier; and the transmitter 530 is further configured to use the result set as a query result and feed the query result back to the client; and the processor 520 is further configured to, if the result set does not exist in the cache and the second query request includes the role identifier and the filter criterion, detect whether data matching the role identifier and the filter criterion exists in a database, and if the data exists in the database, temporarily store the data as a result set using a key value that is generated according to the role identifier and the filter criterion; and the transmitter 530 is further configured to use the result set as a query result and feed the query result back to the client.

If there are at least two role identifiers corresponding to the user identifier, there are at least two second query requests that are in a one-to-one correspondence with the role identifiers, and the transmitter 530 is configured to combine result sets that are obtained through detection according to the second query requests and feed a combined result back to the client.

In conclusion, according to the data query apparatus provided in this embodiment of the present disclosure, it may be set that at least two user identifiers correspond to a same role identifier, and the user identifiers are converted into the corresponding role identifier in a query process, so that a result set that is obtained through querying according to the role identifier may be reused by different clients corresponding to the same role identifier, which resolves a problem in the existing data query method that because of different user identifiers of clients, a reusing rate of a result set is extremely low and the data query efficiency is lowered, and achieves an effect of improving the reusing efficiency of a result set and the data query efficiency. In addition, if there are at least two role identifiers corresponding to a user identifier, there are at least two second query requests that are in a one-to-one correspondence with the role identifiers; and result sets obtained through detection according to second query requests are combined and a combined result is fed back to a client, so that a union set of the result sets that are obtained through detection according to the second query requests may be acquired by means of one query, which resolves a problem of low data query efficiency that is caused by the fact that one result set is obtained in one query, and achieves an effect of improving the data query efficiency.

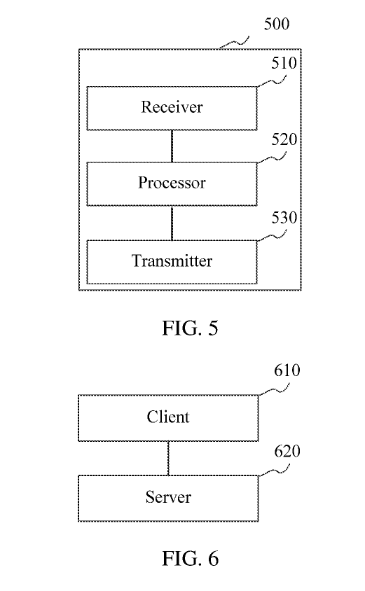

Referring to FIG. 6, FIG. 6 is a schematic structural diagram of a data query system according to an embodiment of the present disclosure. The data query system may include a client 610 and a server 620.

The client 610 is configured to send a first query request, where the first query request includes a user identifier.

The server 620 is configured to receive the first query request that is sent by the client 610 and includes the user identifier; convert the user identifier into a role identifier corresponding to the user identifier, to obtain a second query request, where the role identifier corresponds to at least two user identifiers; detect whether a result set having a key value matching the role identifier included in the second query request exists in a cache; and if the result set exists in the cache, use the result set as a query result and feed the query result back to the client 610.

In conclusion, according to the data query system provided in this embodiment of the present disclosure, it may be set that at least two user identifiers correspond to a same role identifier, and the user identifiers are converted into the corresponding role identifier in a query process, so that a result set that is obtained through querying according to the role identifier may be reused by different clients corresponding to the same role identifier, which resolves a problem in the existing data query method that because of different user identifiers of clients, a reusing rate of a result set is extremely low and the data query efficiency is lowered, and achieves an effect of improving the reusing efficiency of a result set and the data query efficiency.

A data query system provided in another embodiment of the present disclosure may include a client 610 and a server 620.

The client 610 is configured to send a first query request, where the first query request includes a user identifier.

The server 620 is configured to receive the first query request that is sent by the client 610 and includes the user identifier; convert the user identifier into a role identifier corresponding to the user identifier, to obtain a second query request, where the role identifier corresponds to at least two user identifiers; detect whether a result set having a key value matching the role identifier included in the second query request exists in a cache; and if the result set exists in the cache, use the result set as a query result and feed the query result back to the client 610.

If the first query request further includes a filter criterion, the server 620 is configured to detect whether a result set having a key value matching the role identifier and the filter criterion that are included in the second query request exists in the cache.

The server 620 is configured to acquire a prestored mapping relationship between the user identifier and the role identifier; and change the user identifier into the role identifier according to the mapping relationship, to obtain the second query request.

The server 620 is further configured to, if the result set does not exist in the cache and the second query request includes the role identifier, detect whether data matching the role identifier exists in a database, and if the data exists in the database, temporarily store the data as a result set using a key value generated according to the role identifier, use the result set as a query result, and feed the query result back to the client 610; and if the result set does not exist in the cache and the second query request includes the role identifier and the filter criterion, detect whether data matching the role identifier and the filter criterion exists in a database, and if the data exists in the database, temporarily store the data as a result set using a key value that is generated according to the role identifier and the filter criterion, use the result set as a query result, and feed the query result back to the client 610.

If there are at least two role identifiers corresponding to the user identifier, there are at least two second query requests that are in a one-to-one correspondence with the role identifiers, and the server 620 is configured to combine result sets that are obtained through detection according to the second query requests and feed a combined result back to the client.

In conclusion, according to the data query system provided in this embodiment of the present disclosure, it may be set that at least two user identifiers correspond to a same role identifier, and the user identifiers are converted into the corresponding role identifier in a query process, so that a result set that is obtained through querying according to the role identifier may be reused by different clients corresponding to the same role identifier, which resolves a problem in the existing data query method that because of different user identifiers of clients, a reusing rate of a result set is extremely low and the data query efficiency is lowered, and achieves an effect of improving the reusing efficiency of a result set and the data query efficiency. In addition, if there are at least two role identifiers corresponding to a user identifier, there are at least two second query requests that are in a one-to-one correspondence with the role identifiers; and result sets obtained through detection according to second query requests are combined and a combined result is fed back to a client, so that a union set of the result sets that are obtained through detection according to the second query requests may be acquired by means of one query, which resolves a problem of low data query efficiency that is caused by the fact that one result set is obtained in one query, and achieves an effect of improving the data query efficiency.

It should be noted that the described apparatus embodiment is merely exemplary. The units described as separate parts may or may not be physically separate, and parts displayed as units may or may not be physical units, may be located in one position, or may be distributed on a plurality of network units. Some or all of the modules may be selected according to actual needs to achieve the objectives of the solutions of the embodiments. In addition, in the accompanying drawings of the apparatus embodiments provided by the present disclosure, connection relationships between modules indicate that the modules have communication connections with each other, which may be implemented as one or more communications buses or signal cables. A person of ordinary skill in the art may understand and implement the embodiments of the present disclosure without creative efforts.

Based on the description of the foregoing implementation manners, a person skilled in the art may clearly understand that the present disclosure may be implemented by software in addition to necessary universal hardware, or by dedicated hardware, including a dedicated integrated circuit, a dedicated central processing unit (CPU), a dedicated memory, a dedicated component, and the like. Generally, any functions that can be performed by a computer program can be easily implemented using corresponding hardware. Moreover, a specific hardware structure used to achieve a same function may be of various forms, for example, in a form of an analog circuit, a digital circuit, a dedicated circuit, or the like. However, as for the present disclosure, software program implementation is a better implementation manner in most cases. Based on such an understanding, the technical solutions of the present disclosure essentially or the part contributing to the prior art may be implemented in a form of a software product. The software product is stored in a readable storage medium, such as a floppy disk, a universal serial bus (USB) flash drive, a removable hard disk, a read-only memory Read-Only Memory (ROM), a random access memory Random Access Memory (RAM), a magnetic disk, or an optical disc of a computer, and includes several instructions for instructing a computer device (which may be a personal computer, a server, a network device, and the like) to perform the methods described in the embodiments of the present disclosure. The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A data query method, comprising:
receiving a first query request sent by a client, wherein the first query request comprises a user identifier;
converting the user identifier into a role identifier corresponding to the user identifier, to obtain a second query request, wherein the role identifier corresponds to at least two user identifiers;
detecting whether a result set having a key value matching the role identifier comprised in the second query request exists in a cache; and
feeding a query result corresponding to the result set back to the client when the result set exists in the cache.

2. The data query method according to claim 1, wherein the first query request further comprises a filter criterion, and wherein the detecting whether the result set having the key value matching the role identifier comprised in the second query request exists in a cache comprises detecting whether a result set having a key value matching the role identifier and the filter criterion that are comprised in the second query request exists in the cache.

3. The data query method according to claim 1, wherein converting the user identifier into the role identifier corresponding to the user identifier comprises:
acquiring a prestored mapping relationship between the user identifier and the role identifier; and
changing the user identifier into the role identifier according to the prestored mapping relationship in order to obtain the second query request.

4. The data query method according to claim 1, further comprising:
detecting whether data matching the role identifier exists in a database when the result set does not exist in the cache and the second query request comprises the role identifier;
temporarily storing the data as a result set using a key value generated according to the role identifier when the data exists in the database; and
feeding a query result corresponding to the result set back to the client.

5. The data query method according to claim 1, further comprising:
detecting whether data matching the role identifier and a filter criterion exists in a database when the result set does not exist in the cache and the second query request comprises the role identifier and the filter criterion;
temporarily storing the data as a result set using a key value that is generated according to the role identifier and the filter criterion when the data exists in the database; and
feeding a query result corresponding to the result set back to the client.

6. The data query method according to claim 1, wherein there are at least two role identifiers corresponding to the user identifier, wherein there are at least two second query requests that are in a one-to-one correspondence with the at least two role identifiers, and wherein the feeding the query result corresponding to the result set back to the client comprises combining result sets that are obtained according to the at least two second query requests and feeding a combined result back to the client.

7. A server, comprising:
a receiver configured to receive a first query request sent by a client, wherein the first query request comprises a user identifier;
a processor coupled to the received and configured to:
convert the user identifier received by the receiver into a role identifier corresponding to the user identifier in order to obtain a second query request, wherein the role identifier corresponds to at least two user identifiers; and
detect whether a result set having a key value matching the role identifier comprised in the second query request exists in a cache; and
a transmitter coupled to the processor and configured to feed a query result corresponding to the result set back to the client when the processor detects that the result set exists in the cache.

8. The server according to claim 7, wherein the first query request further comprises a filter criterion, and wherein the processor is configured to detect whether a result set having a key value matching the role identifier and the filter criterion that are comprised in the second query request exists in the cache.

9. The server according to claim 7, wherein the processor is configured to:
acquire a prestored mapping relationship between the user identifier and the role identifier; and
change the user identifier into the role identifier according to the prestored mapping relationship in order to obtain the second query request.

10. The server according to claim 7, wherein the processor is further configured to:
detect whether data matching the role identifier exists in a database when the result set does not exist in the cache and the second query request comprises the role identifier, and
temporarily store the data as a result set using a key value generated according to the role identifier when the data exists in the database, and
wherein the transmitter is further configured to feed a query result corresponding to the result set back to the client.

11. The server according to claim 7, wherein the processor is further configured to:
detect whether data matching the role identifier and a filter criterion exists in a database when the result set does not exist in the cache and the second query request comprises the role identifier and the filter criterion, and
temporarily store the data as a result set using a key value that is generated according to the role identifier and the filter criterion when the data exists in the database, and
wherein the transmitter is further configured to feed a query result corresponding to the result set back to the client.

12. The server according to claim 7, wherein there are at least two role identifiers corresponding to the user identifier, wherein there are at least two second query requests that are in a one-to-one correspondence with the at least two role identifiers, and wherein the transmitter is configured to combine result sets that are obtained according to the at least two second query requests and feed a combined result back to the client.

13. A data query system, comprising:
a client is configured to send a first query request, wherein the first query request comprises a user identifier; and
a server is configured to:
receive the first query request sent by the client;
convert the user identifier comprised in the first query request into a role identifier corresponding to the user identifier in order to obtain a second query request, wherein the role identifier corresponds to at least two user identifiers;
detect whether a result set having a key value matching the role identifier comprised in the second query request exists in a cache; and
feeding a query result corresponding to the result set back to the client when the result set exists in the cache.

14. The data query system according to claim 13, wherein the first query request further comprises a filter criterion, and wherein the server is configured to detect whether a result set having a key value matching the role identifier and the filter criterion that are comprised in the second query request exists in the cache.

15. The data query system according to claim 13, wherein the server is configured to:
acquire a prestored mapping relationship between the user identifier and the role identifier; and
change the user identifier into the role identifier according to the prestored mapping relationship in order to obtain the second query request.

16. The data query system according to claim 13, wherein the server is further configured to:
detect whether data matching the role identifier exists in a database when the result set does not exist in the cache and the second query request comprises the role identifier,
temporarily store the data as a result set using a key value generated according to the role identifier when the data exists in the database; and
feeding a query result corresponding to the result set back to the client;

17. The data query system according to claim 13, wherein the server is further configured to:
detect whether data matching the role identifier and a filter criterion exists in a database when detecting that the result set does not exist in the cache and the second query request comprises the role identifier and the filter criterion,
temporarily store the data as a result set using a key value that is generated according to the role identifier and the filter criterion when the data exists in the database; and
feeding a query result corresponding to the result set back to the client.

18. The data query system according to claim 13, wherein there are at least two role identifiers corresponding to the user identifier, wherein there are at least two second query requests that are in a one-to-one correspondence with the at least two role identifiers, and wherein the server is configured to combine result sets that are obtained according to the at least two second query requests and feed a combined result back to the client.
